(19) United States
(12) Patent Application Publication
(10) Pub. No.: US 2017/0061313 A1
(43) Pub. Date: Mar. 2, 2017

(54) System and Method for Estimating a Performance Metric

(71) Applicant: Infineon Technologies AG, Neubiberg (DE)

(72) Inventors: Anamaria Oros, Cluj-Napoca (RO); Andi Buzo, Bucharest (RO); Monica Rafaila, Munchen (DE); Georg Pelz, Ebersberg (DE); Marina Dana Gherman Topa, Cluj-Napoca (RO)

(21) Appl. No.: 14/843,746

(22) Filed: Sep. 2, 2015

(51) Int. Cl. G06N 7/00; G06F 11/30; G06F 17/50; G06F 11/34

(52) U.S. Cl. CPC G06N 7/005; G06F 11/3409; G06F 11/3024; G06F 17/5009

(57) ABSTRACT

A performance estimation method includes determining, for a device response that is dependent on first factors and second factors, a plurality of response distributions including at least one of: a measured response distribution of a production set corresponding to a setting of the first factors, the production set including a plurality of manufactured units; a response distribution simulated in accordance with a simulation model and with a combined factor setting of the first factors and the second factors; and a response distribution estimated in accordance with the combined factor setting and in accordance with a response prediction model relating the device response to the first factors and to the second factors. The method also includes estimating, in accordance with the plurality of response distributions, a performance metric prediction model relating a performance metric to the first factors.

### TECHNICAL FIELD

The present invention relates generally to a system and method for performance estimation, and, in particular embodiments, to a system and method for estimating a performance metric.

### BACKGROUND

A performance metric is an important evaluation statistic that measures the quality of distributions of responses of a system relative to desired or specified requirements. The system may be, for example, a device or a design for a device. The values of the responses that make up the distribution of responses may each depend of a variety of input factors of the system such as, for example, a property of a component (e.g., magnetizing inductance of a voltage regulator), a characteristic of a stimulus of the device (e.g., temperature), or any other system parameter or system setting that may impact a system response.

Examples of performance metrics include statistical dispersion, failure probability, process Capability Index (Cₚₖ), Design Index (DI) and Worst Case Distance (WCD). Statistical dispersion denotes how stretched or squeezed is the response distribution as measured by, for example, the response distribution's variance, standard deviation, interquartile range, etc. Cₚₖ is a performance metric that incorporates the position and the dispersion of the distribution with regard to distribution requirements. The DI incorporates the position of the distribution median and the inter-quantile range with regard to distribution requirements. The WCD is a performance metric that quantifies the distance of distal quantiles of the response distribution from a requirements failure point.

### SUMMARY OF THE INVENTION

In accordance with a first example embodiment of the present invention, a performance estimation method is provided. The method includes determining, for a device response that is dependent on first factors and second factors, a plurality of response distributions including at least one of: a measured response distribution of a production set corresponding to a setting of the first factors, the production set including a plurality of manufactured units; a response distribution simulated in accordance with a simulation model and with a combined factor setting of the first factors and the second factors; and a response distribution estimated in accordance with the combined factor setting and in accordance with a response prediction model relating the device response to the first factors and to the second factors. The method also includes estimating, in accordance with the plurality of response distributions, a performance metric prediction model relating a performance metric to the first factors.

In accordance with a second example embodiment of the present invention, a performance estimation circuit is provided. The circuit is configured to determine, for a device response that is dependent on first factors and second factors, a plurality of response distributions including at least one of: a measured response distribution of a production set corresponding to a setting of the first factors, the production set including a plurality of manufactured units; a response distribution simulated in accordance with a simulation model and with a combined factor setting of the first factors and the second factors; and a response distribution estimated in accordance with the combined factor setting and in accordance with a response prediction model relating the device response to the first factors and to the second factors. The circuit is also configured to estimate, in accordance with the plurality of response distributions, a performance metric prediction model relating a performance metric to the first factors.

In accordance with a third example embodiment of the present invention, a method is provided for fabricating an integrated circuit. The method includes: selecting a candidate design; determining a plurality of response distributions each corresponding to a respective setting of first factors and a respective plurality of random values of second factors; estimating, in accordance with the plurality of response distributions, a performance metric prediction model relating a performance metric to the first factors; and estimating, in accordance with the performance metric prediction model, a performance metric value of the candidate design.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a flow diagram illustrating a method for identifying a worst case performance scenario using a prediction model (i.e., “metamodel”) of a performance metric;

FIG. 2 is a table illustrating a Design of Experiments (DoE) matrix for developing a metamodel that estimates the dependence of an arbitrary response variable on a set of input factors, in accordance with embodiments of the present invention;

FIG. 3A is a flow diagram illustrating a method for developing a linear regression metamodel for a response of a device in accordance with embodiments of the present invention;

FIG. 3B is a table illustrating a DoE matrix for developing a device response metamodel for a response that is of interest for a candidate design of a device, in accordance with embodiments of the present invention;

FIG. 4 shows a DoE matrix for developing a performance metric metamodel for a performance metric that is of interest for a candidate design of the device, where this performance metric is affected by several different settings of controllable factors of the design, in accordance with embodiments of the present invention;

FIG. 5A is a flow diagram illustrating a method to determine a performance metric metamodel in accordance with embodiments of the present invention;

FIG. 5B is a flow diagram illustrating an alternative method to determine a performance metric metamodel in accordance with embodiments of the present invention;

FIG. 5C is a flow diagram illustrating another alternative method to determine a performance metric metamodel in accordance with embodiments of the present invention;

FIG. 6A is a flow diagram illustrating a method for designing a device using a performance metric metamodel, in accordance with embodiments of the present invention;

FIG. 6B is a flow diagram illustrating an alternative method for designing a device using a performance metric metamodel, in accordance with embodiments of the present invention;

FIG. 7 is a block diagram illustrating a software application that uses a performance metric metamodel in accordance with embodiments of the present invention; and

FIG. 8 is a block diagram of a processing system that may be used for implementing some of the devices and methods disclosed herein in accordance with embodiments of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, a system and method for obtaining a selected performance metric for an electronic device that is being designed or evaluated using, for example, Electronic Design Automation (EDA) tools, other analysis and verification tools, dedicated instrumentation, etc. Further embodiments may be applied to obtaining performance metrics for non-electronic systems.

In an embodiment directed toward circuit design, a prediction model (i.e., “metamodel”) is made of a circuit in order to efficiently identify worst case simulation and/or testing scenarios. A metamodel for a performance metric of the circuit may be estimated using values of a circuit response. These response values may be obtained, for example, by direct measurements, simulations, or by an estimation technique. The circuit response is dependent on a number of factors that include both Controllable Factors (CFs) and Uncontrollable Factors (UFs). In some embodiments, the circuit response values may be estimated from a previous metamodel that relates the circuit response to both the CFs and UFs that affect the circuit response. A second metamodel may then be estimated that relates the performance metric to the CFs that affect the performance metric.

The CFs that affect the response and the performance metric of a device are factors that can be set with high precision, such as, for example, pre-determined environmental parameters that are controllable in a laboratory (e.g., temperature, pressure, etc.), design parameters (e.g., software settings, component values of a design, etc.) or external component values or inputs that can be set with high precision (e.g., supply voltages). Examples of design component values that may be CFs include resistances, inductances, capacitances, diode forward voltages, transformer turns ratios, electronic oscillator frequencies, output bandwidths of analog or digital filters, amplification levels of operational amplifiers or power amplifiers, transistor threshold voltages, antenna wavelengths, spring constants, material strengths, etc. The UFs that affect a device response may be, for example, those factors that are difficult to control in physical devices, such as, for example, production process parameters, external load characteristics, randomly varying environmental parameters, and randomly varying electrical inputs (e.g., input data signals, random clock jitter, etc.)

Although some factors may be difficult to control in physical devices, they may still be set to a desired setting in a simulation environment or metamodel. Furthermore, many environmental parameters are difficult to control in real-world applications but may be more easily controlled in a laboratory using, for example, an environmental test chamber. Thus, in some embodiments the same factor may be selected for use as either a CF or a UF. For example, distributions of the response may be obtained at pre-determined temperature settings that provide experimental coverage of an expected operating range. In this example, the pre-determined temperature is a CF. As a second example, response distributions may be obtained at experimental CF settings while allowing the operating temperature to randomly vary in accordance with, e.g., a building temperature, an outdoor temperature, or an operating motor temperature. In this second example, the randomly varying operating temperature is a UF.

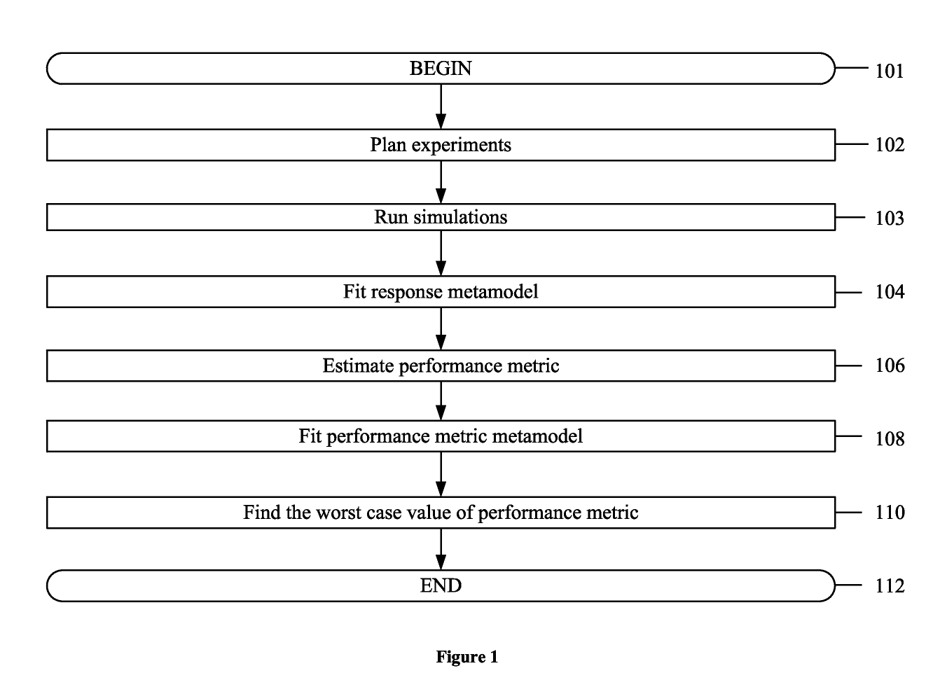

FIG. 1 shows a flow diagram for an embodiment method for estimating a performance metric metamodel, using a previous metamodel for a response of a device in accordance with a particular design. The method begins at step 101. At step 102, a first experiment is planned for determining a metamodel of the device response. The experimental plan includes settings for the CFs and UFs. At step 103, simulations are run at each of these planned settings. At step 104, a response metamodel is fitted for the device response. This response metamodel relates the device response to the CFs and UFs that affect it. At step 106, values of a performance metric are estimated from response distributions, where the response distributions are estimated using the device response metamodel. In some embodiments, the response distributions may be generated at different CF settings by varying the UFs randomly. At step 108, a second metamodel is fitted that is a performance metric metamodel relating the performance metric to the CFs that affect it. At step 110, a worst case value of the performance metric is found using the performance metric metamodel. The method ends at step 112.

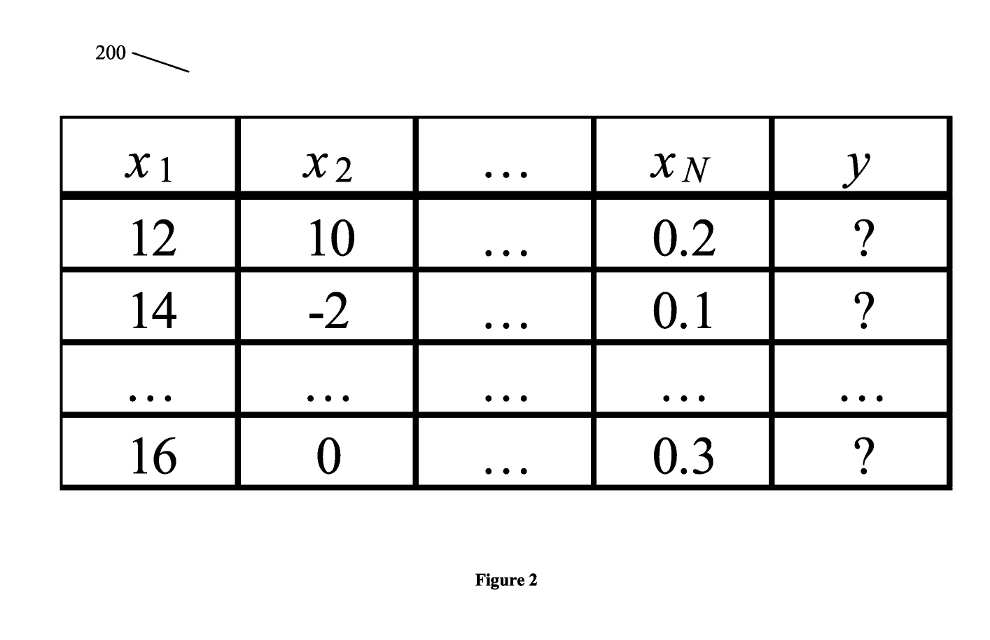

FIG. 2 shows an embodiment Design of Experiments (DoE) matrix 200 for developing a prediction model (i.e., “metamodel”). In this embodiment, the metamodel to be developed is an estimate of the dependence of an arbitrary response variable y on a set of input factors X={x₁, x₂, . . . , xₙ}. The metamodel is calculated based on values of the arbitrary response variable, represented by the rightmost column of DoE matrix 200, and this metamodel may be, for example, a statistical linear regression model. Exemplary values for the input factors X are shown in the other columns of DoE matrix 200, and are varied in accordance with a full grid of values or a chosen subset within the ranges of possible values for the factors. The values of the arbitrary response variable y may be obtained from, for example, experimental runs that include simulations or physical measurements. The arbitrary response variable may be a response of a device having a particular design such as, for example, a voltage regulator using a particular kind of switching bridge. The arbitrary response variable may also be, for example, a performance metric that is related to a distribution of several such responses of the design, such as, for example, failure probability, statistical dispersion, process Capability Index (Cpk), Design Index (DI) and Worst Case Distance (WCD).

Statistical dispersion denotes how stretched or squeezed the response distribution is, as measured by, for example, the response distribution's variance, standard deviation, interquartile range, etc. The Cₚₖ is a measure that estimates the position of the distribution with regard to specification limits, with a higher Cₚₖ indicating that the distribution mean is farther from violating these limits. If the response's distribution is Gaussian then statistical inferences can be estimated using Cₚₖ. The Cₚₖ can be calculated using Equation 1, in terms of the Lower Specification Limits (LSL), the Upper Specification Limits (USL), the mean μ of the response distribution, and the standard deviation a of the response distribution:

$${C}_{pk} = min [ \frac{USL - μ}{3 σ} , \frac{μ - USL}{3 σ} ] \qquad ( 1 )$$

The DI is an alternative measure to Cₚₖ that may be used when the response distribution is asymmetric. A higher DI indicates that the distribution median is farther from violating specification limits. Unlike Cₚₖ, DI does not use information about the mean but instead uses the median η(y) of the response distribution, and the standard deviation is replaced with quantiles for measuring the spread of the distribution. These quantiles may have smaller variation and therefore be more stable measures than the standard deviation, which may be affected by extreme points of the distribution. A quantile function Q_{y} is used to calculate the quantiles of the DI, and a wide variety of inputs to the quantile function may be chosen that result in different quantile coverage of the DI calculation. For Gaussian distributions, when quantiles of 99.7% (corresponding to μ±3σ) are imposed, the DI and Cₚₖ become equivalent, and DI may be calculated, for example, using Equation 2, where 0.0015 and 0.9985 are exemplary values chosen in order to ensure 99.7% coverage:

$$DI = min [ \frac{η ( y ) - LSL}{η ( y ) - {Q}_{y} ( 0.0015 )} , \frac{USL - η ( y )}{{Q}_{y} ( 0.9985 ) - η ( y )} ] \qquad ( 2 )$$

The WCD is a performance metric that quantifies the distance of distal quantiles of the response distribution from a failure point, with a greater WCD indication a greater distance from the specification limits. The WCD may be advantageous for embodiments where failures have extreme results, such as, for example, in automotive safety embodiments. WCD can be estimated using Equation 3:

$$WCD = min [ \frac{{Q}_{y} ( 0.0015 ) - LSL}{USL - LSL} , \frac{USL - {Q}_{y} ( 0.9985 )}{USL - LSL} ] \qquad ( 3 )$$

Referring again to FIG. 2, each row of the DoE matrix 200 for determining the metamodel is a respective setting of the values of input factors at an experimental run. The selection of these factor settings affects the accuracy of the metamodel. In an embodiment, the DoE 200 is designed in accordance with prior knowledge about the system.

As is known to one skilled in the art of Response Surface Methodology (RSM), a full-grid experiment includes experimental runs corresponding to settings for all possible combinations of values across all factors. The embodiment DoE 200 may also be made of a carefully chosen subset of the full grid based on several optimality criteria that are known to one of skill in the art, including, for example, A-optimality, C-optimality, D-optimality, E-optimality, T-optimality, G-optimality, I-optimality, and V-optimality. Such an optimized DoE 200 may develop some of the most important RSM information while using a fraction of the experimental runs of the corresponding full grid experiment. For example, an A-optimal experiment results in minimizing the average variance of the estimates of the regression coefficients, and a G-optimal experiment results in minimizing the maximum variance of the response values estimated by the linear regression. As a further example, when experimental settings for finding a linear regression estimate of a response are D-optimal, the experimental results maximize the differential Shannon information content of the regression coefficients. Such a D-optimal experiment reduces the total number of experimental runs N required to determine an accurate linear regression dependent on n factors down to the quantity shown on the left-hand side of Equation 4:

N=1+n+n(n+1)/2 (4)

In linear regression embodiments of a metamodel to be developed by the DoE 200, generalized linear regression may be used to develop a response estimate ŷ based on polynomials and factor interactions of any order. By using prior knowledge of the system, one may also develop the response estimate based on other linear terms, such as square root, logarithm, etc. Using, for example, a second-order polynomial with first order interactions for a linear regression metamodel may be suitable at least in cases where the factors vary within small tolerances around a nominal value. Such a metamodel may take the form of Equation 5:

$$\hat{y} = f ( X ) = {b}_{0} + {\sum }_{i = 1}^{n} {b}_{i} {x}_{i} + {\sum }_{i = 1}^{n} {\sum }_{j \geq i}^{n} {b}_{ij} {x}_{i} {x}_{j} \qquad ( 5 )$$

An algorithm for developing a linear regression metamodel may, for example, seek to minimize a function of the residuals, i.e., the errors between the response estimate and the value of the response variable for each setting of the factors of the DoE 200. Such an algorithm may also validate whether the metamodel meets a fitting criteria. To prevent the fitness validation from depending on the response variable's scale, the fitting criteria may use normalized residuals calculated according to Equation 6. In Equation 6, ρ(i) is the normalized residual of the ith experimental run, while N is the total number of experimental runs:

$$ρ ( i ) = \frac{\hat{y} ( i ) - y ( i )}{{max}_{i = 1 , N} y - {min}_{i = 1 , N} y} \qquad ( 6 )$$

Criteria for fitting a linear regression metamodel developed using DoE 200 may be based on, for example, the maximum value or the mean value. In addition, a normality statistic test may be used to determine whether the set of normalized residuals has a Gaussian distribution. Such statistical tests may include, for example, a Lilliefors test, an Anderson-Darling test, a Smirnoff test, etc.

So that the interpolation capability of the metamodel may be quantified, in some embodiments the factor settings (and resulting response values) generated for fitness validation are different from those of DoE 200 that were used to develop the linear regression metamodel. Such fitness validation factor settings may be obtained by varying the factors randomly. In this disclosure, the terms “randomly” and “random” encompass descriptions of both random and pseudo-random processes and values, including Monte Carlo processes and the values generated by them.

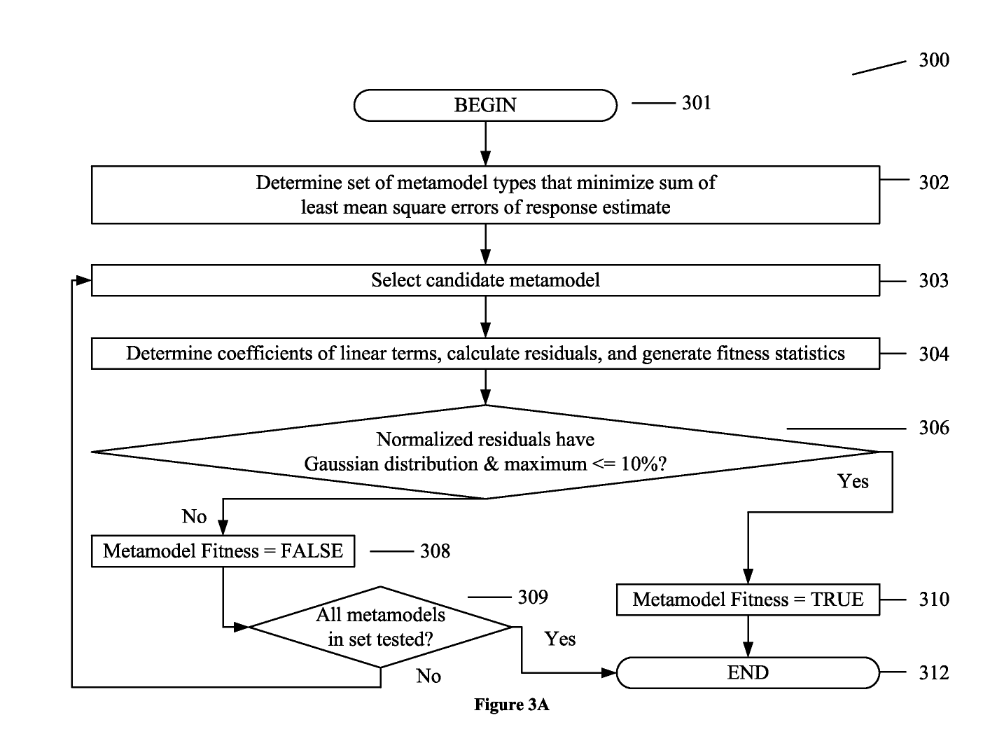

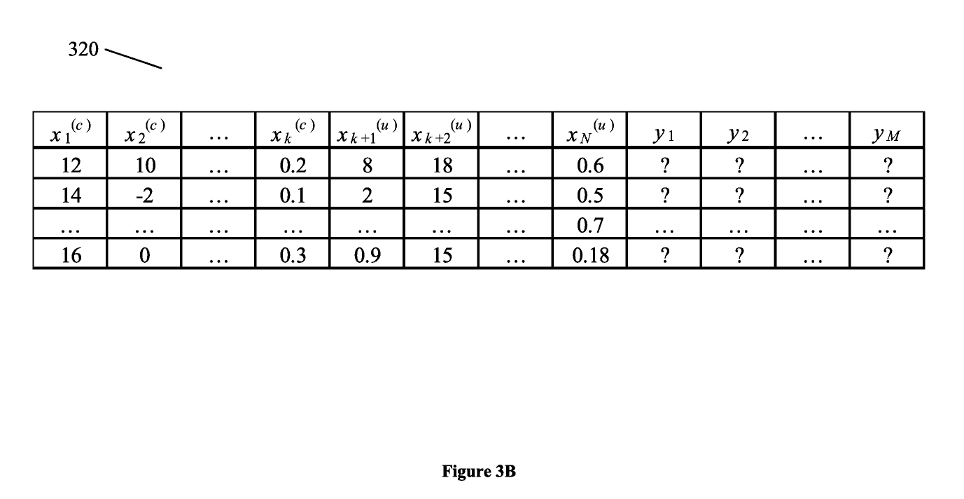

In FIG. 3A, a flow diagram shows an embodiment method 300 for developing a linear regression metamodel by finding the set of regression coefficients {bᵢ, bᵢⱼ} of Equation 5. The linear regression metamodel that is obtained by the embodiment method of FIG. 3A is a metamodel for responses of a candidate design of a device. The method begins at step 301. At step 302 of the embodiment of FIG. 3A, the method determines a set of one or more possible types of metamodels for minimizing the sum of the least mean square errors of the response estimate. At step 303, a candidate metamodel is selected from the set of possible metamodels. At step 304, the linear regression terms are determined (i.e., the metamodel is fit), the normalized residuals are calculated, and statistics are generated from these normalized residuals to be used in validating fitness of the linear regression metamodel. These statistics include the maximum value and a normality test statistic of the normalized residuals of the metamodel. At step 306, the method tests whether the value of the maximum normalized residual is not more than 10% and whether the set of normalized residuals has a Gaussian distribution. If either of these conditions is not met, flow continues at step 308, but if both conditions are met, flow continues at step 310, where the fitness of the candidate metamodel is assessed at TRUE, and then the method ends at step 312. At step 308, the fitness of the candidate metamodel is assessed as FALSE, and flow continues at step 309. At step 309, a flow decision is made based on whether all the metamodels have been tested that are in the set of metamodels that minimize the sum of the least mean square errors of the response estimate. If not all the metamodels in the set have been tested, flow returns to step 303, and otherwise the method ends at step 312.

FIG. 3B shows an embodiment DoE matrix 320 for developing such a metamodel for device responses Y={y₁, y₂, . . . , y_{M}} that are of interest for a candidate design of a device. The device responses Y are dependent on X in accordance with a relationship F={f₁, f₂, . . . , f_{M}} such that Y=F(X)={f₁(X), f₂(X), . . . , f_{M} (X)}. These device responses are affected by N factors X={X_{c}, Xᵤ}={x₁^{(c)}, x₂^{(c)}, . . . , xₖ^{(c)}, xₖ₊₁^{(u)}, xₖ₊₂^{(u)}, . . . , x_{N}^{(u)}}, including k CFs X_{c} and N−k Uncontrollable Factors UFs Xᵤ.

In some embodiments, the linear regression metamodel for the response of the candidate design may be useful for determining a dependence of a performance metric ξ of the candidate design upon the CFs. The performance metric of interest may be expressed as ξ=H(Ψ(Y), Ω), where Ω is a set of requirements of a distribution Ψ(Y) of device responses Y, and H is a function showing the dependence of ξ on Ψ(Y) and Ω. The requirements Ω may be, for example, a function of the distance of the device responses from specification limits, a required tightness of the response distribution, etc. Since the distribution Ψ(Y) of the device responses is dependent on the CFs, the performance metric of interest may also be expressed as a function G that is dependent on the CFs X_{c} and on Ω, or ξ=G(X_{c}, Ω), and for a given set of requirements Ω a performance metric metamodel may be estimated as a function g(X_{c}), where ξ=g(X_{c}). In an embodiment, the estimation of the performance metric metamodel allows the plotting of the performance metric against a subset of selected CFs, which may be, for example, the CFs deemed most important by the designer of a device. The performance metric metamodel regression coefficients may also be inspected to determine the CF that has the greatest effect on the metric.

In an embodiment, the performance metric metamodel may be used for finding a worst case set of values for the CFs X_{c}={x₁^{(c)}, x₂^{(c)}, . . . , xₖ^{(c)}} that minimizes the performance metric metamodel function g(X_{c}). If the worst case performance metric value satisfies the specification limits, then any other case satisfies it. If the worst case metric does not satisfy the specification limits, then by the means of the performance metric metamodel the acceptable range of CF values may be determined that result in a performance metric that satisfies the specification limits. The design may then be adjusted so that performance metric meets the specification limits.

In another embodiment, a performance metric metamodel may be used for finding an optimal set of values for the CFs X_{c}={x₁^{(c)}, x₂^{(c)}, . . . , xₖ^{(c)}} that maximizes the performance metric metamodel function g(X_{c}). A variety of search algorithms may be used for finding these optimal CF values, such as, for example, gradient-based algorithms, random number generation algorithms, etc.

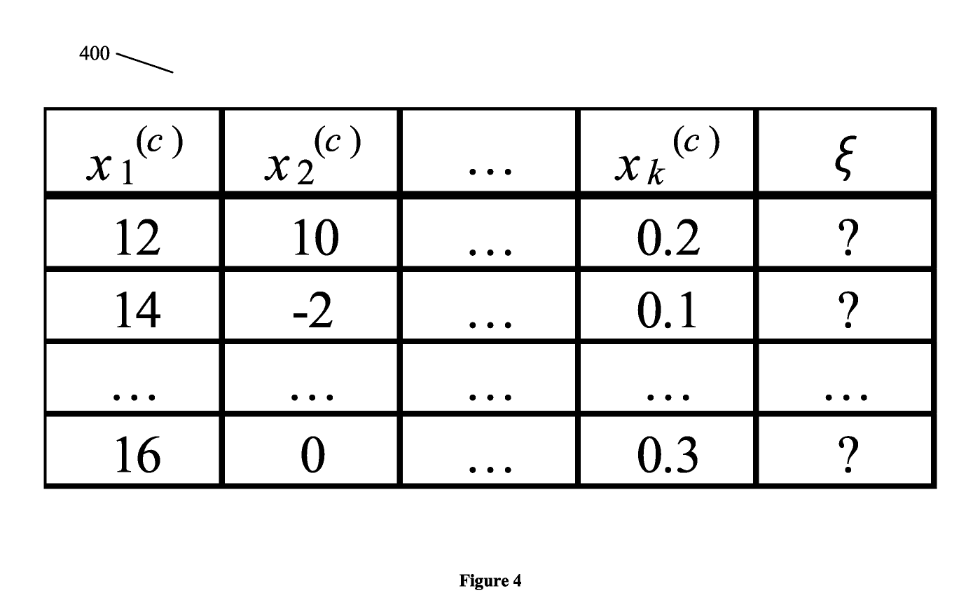

FIG. 4 shows an embodiment DoE matrix 400 for developing such a metamodel for a performance metric ξ that is of interest for the candidate design of the device, where this performance metric ξ is affected by several different settings of the CFs X_{c}. Multiple responses of the device may be obtained at each row of the DoE, where each row is a different setting of the CFs. These multiple device responses may be obtained by varying the UFs randomly while the respective CF setting is maintained constant. Each such set of multiple device responses corresponding to each row of the DoE has a response distribution. These multiple response distributions are used to calculate the multiple values of the performance metric corresponding to the rightmost column of the embodiment DoE of FIG. 4. The multiple response distributions may include, for example, unimodal distributions, multimodal distributions having multiple local maxima, or any combination of the foregoing.

In an embodiment, these device response distributions may be obtained by estimating the device responses using a device response metamodel, which relative to experimental costs may allow an increase in the number of CF settings or the number of random UF settings used for each CF setting of the DoE. In an alternative embodiment, the device response distributions are obtained at each CF setting of the DoE from direct simulations of a simulation model that is an electronic design replica approximating the behavior of a real device built according to the design. This electronic design replica may be, for example, a digital prototype that includes replica design components.

In another alternative embodiment, the device response distributions are obtained from physical measurements of production units. These production units have been manufactured in accordance with the design and exhibit random variations due to UFs such as, for example, random process variations. Each of the production units may be able to be configured in accordance with the CF settings of the embodiment DoE of FIG. 4. In some embodiments, this configuring of the production units includes manufacturing the production units to include design components having values determined by the set values of some or all of the CFs. For each row of the DoE, the device response is physically measured for each of the randomly varying production units that is configured in accordance with the CF setting of that row. A different device response distribution for each setting of the CFs of the DoE is thereby obtained.

Referring again to FIG. 4, once the device response distributions for each row of the DoE have been obtained and the performance metric values of the last column of the DoE have been calculated, a performance metric metamodel may be estimated using, for example, linear regression. In some embodiments, the linear regression technique of method 300 may be used to estimate the performance metric metamodel, where the performance metric is the arbitrary response variable and the CFs are the input factors of method 300. An expression for such a linear regression metamodel of a performance metric may take the form of a second-order polynomial with first-order interactions as expressed in Equation 7, where {cᵢ, cᵢⱼ} are the regression coefficients and k is the number of CFs:

$$ξ = g ( {X}_{c} ) = {c}_{0} + {\sum }_{i = 1}^{k} {c}_{i} {x}_{i}^{( c )} + {\sum }_{i = 1}^{k} {\sum }_{j \geq i}^{k} {c}_{ij} {x}_{i}^{( c )} {x}_{j}^{( c )} \qquad ( 7 )$$

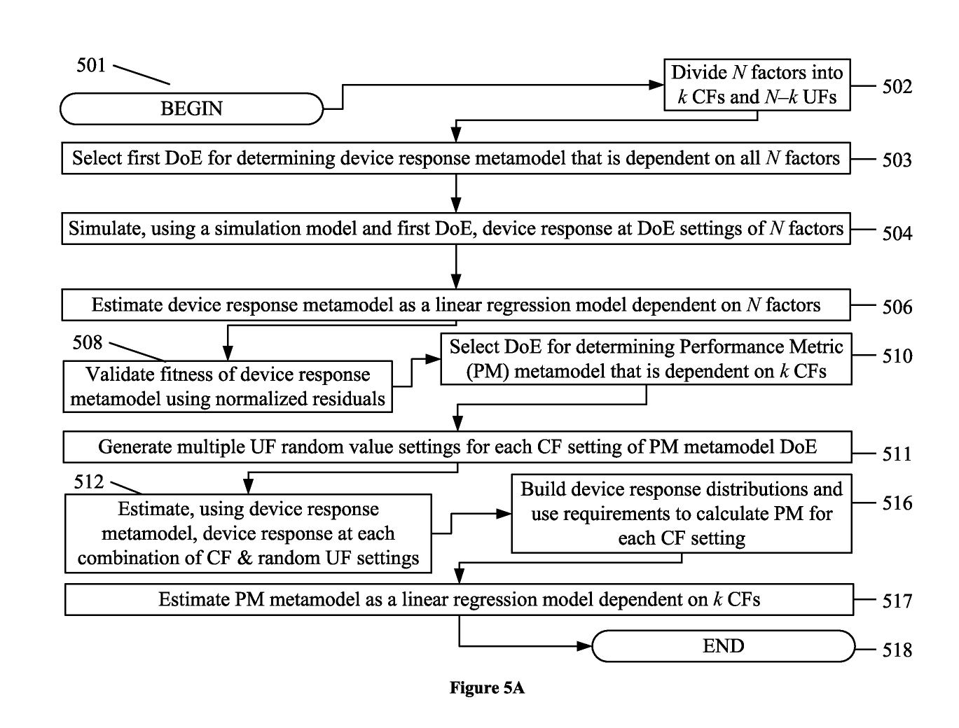

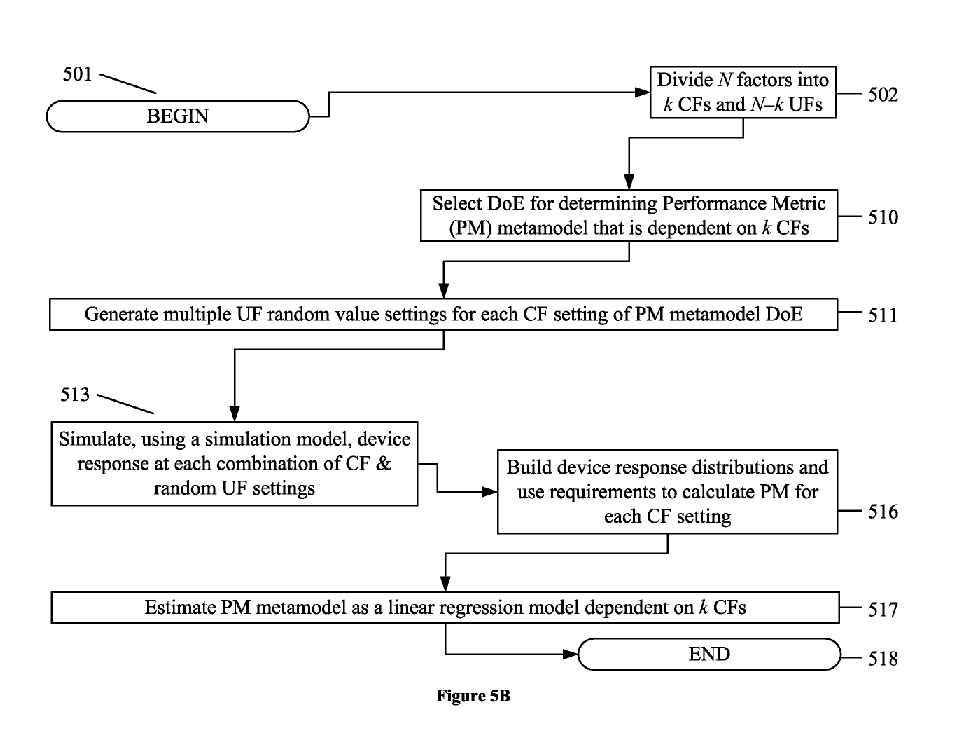

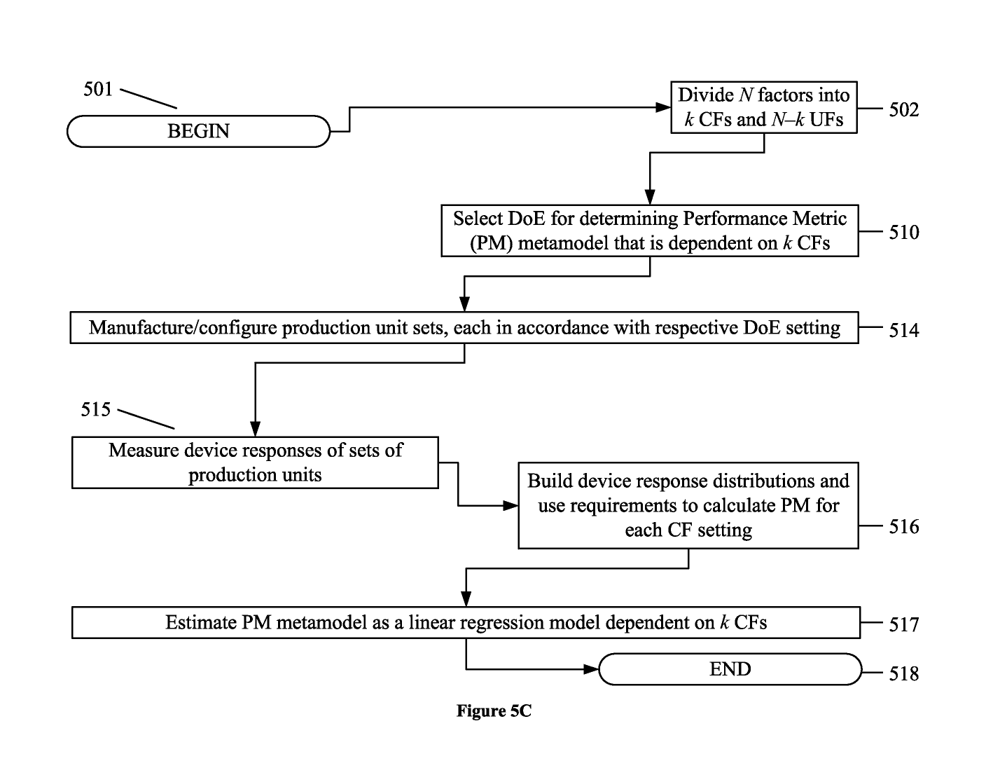

FIG. 5A shows a flow diagram for an embodiment method to determine the performance metric metamodel. The method begins at step 501. At step 502, the set of factors X are split into CFs X_{c} and UFs Xᵤ. In other words, the set of factors X={X_{c}, Xᵤ} is divided into a first subset X_{c}={x₁^{(c)}, x₂^{(c)}, . . . , xₖ^{(c)}} that contains k CFs and a second subset X_{c}={x₁^{(u)}, x₂^{(u)}, . . . , x_{N-k}^{(u)}} that contains N−k UFs. At step 503, a first DoE is selected for determining a metamodel for a device response in accordance with a particular design for a device, where the device response metamodel is dependent on all N factors (both CFs and UFs). At step 504, simulations of a simulation model are run with the CFs and UFs set at the values determined by the first DoE. The simulation model may be an electronic design replica of a real device built according to the design.

At step 506, the device response metamodel is estimated as a linear regression model that is dependent on the N factors. At step 508, the fitness of the device response metamodel is validated using the normalized residuals of Equation 6. In some embodiments, different factor settings may be used for fitness validation than those used in the device response metamodel DoE, and these different factor settings may be obtained by varying the factors randomly.

At step 510, a performance metric of interest is selected, and a second DoE is selected for estimating a metamodel for the performance metric that is dependent on k CFs. At step 511, for each setting of the CFs in the performance metric metamodel DoE, multiple sets of UFs are generated with random values. For example, 300 different settings of UFs may be randomly generated for each setting of the CFs in the performance metric estimation DoE. At step 512, to obtain a different device response distribution for each setting of the CFs in the performance metric metamodel DoE, the device response is estimated using the device response metamodel for each combination of the random UF settings and corresponding CF settings. At step 516, device response distributions are assembled from the device responses that were estimated at step 512, and then multiple respective values of the performance metric are calculated. Each of these multiple performance metric values are calculated based on the set of requirements Q and the characteristics of a respective device response distribution at a respective CF setting. At step 517, a performance metric metamodel is estimated as a linear regression model that is dependent on the k CFs. In some embodiments, this linear regression model may be estimated using the method 300, where the performance metric is the arbitrary response variable and the k CFs are the input factors. This linear regression model may take the form of, for example, the expression of Equation 7. At step 518, the method ends.

Referring now to FIG. 5B, an alternative embodiment of the method of FIG. 5A is shown. In the embodiment of FIG. 5B, steps 503-508 and 512 of FIG. 5A have been replaced by step 513. Instead of obtaining the device response distributions by estimation using a device response metamodel, at step 513 these device response distributions are obtained directly from simulation runs of a simulation model that is an electronic design replica of a device manufactured in accordance with the design. To obtain a different device response distribution for each setting of the CFs in the performance metric metamodel DoE, the device response is simulated for each combination of the random UF settings and corresponding CF settings.

Referring now to FIG. 5C, another alternative embodiment of the method of FIG. 5A is shown. In the embodiment of FIG. 5C, steps 503-508 and 511-512 of FIG. 5A have been replaced by steps 514-515. At step 514, multiple sets of production units of a device are manufactured in accordance with the design. For each CF setting in the performance metric metamodel DoE, a set of production units is respectively manufactured. The production units within each set may exhibit random variations due to, for example, random process variations. Each set in the multiple sets of production units is respectively configured in accordance with one of the CF settings, which may include manufacturing the production units of that set to include component values having the values of some or all of the CFs. At step 515, the device response distributions are obtained directly from physical measurements of the production units. A different device response distribution for each setting of the CFs is thereby obtained.

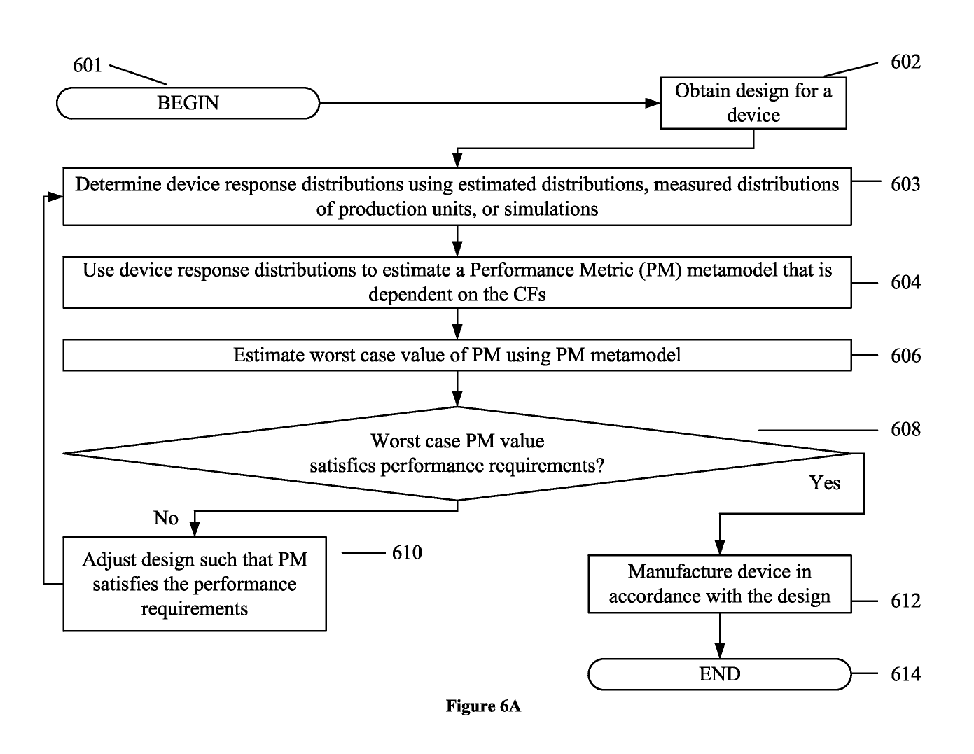

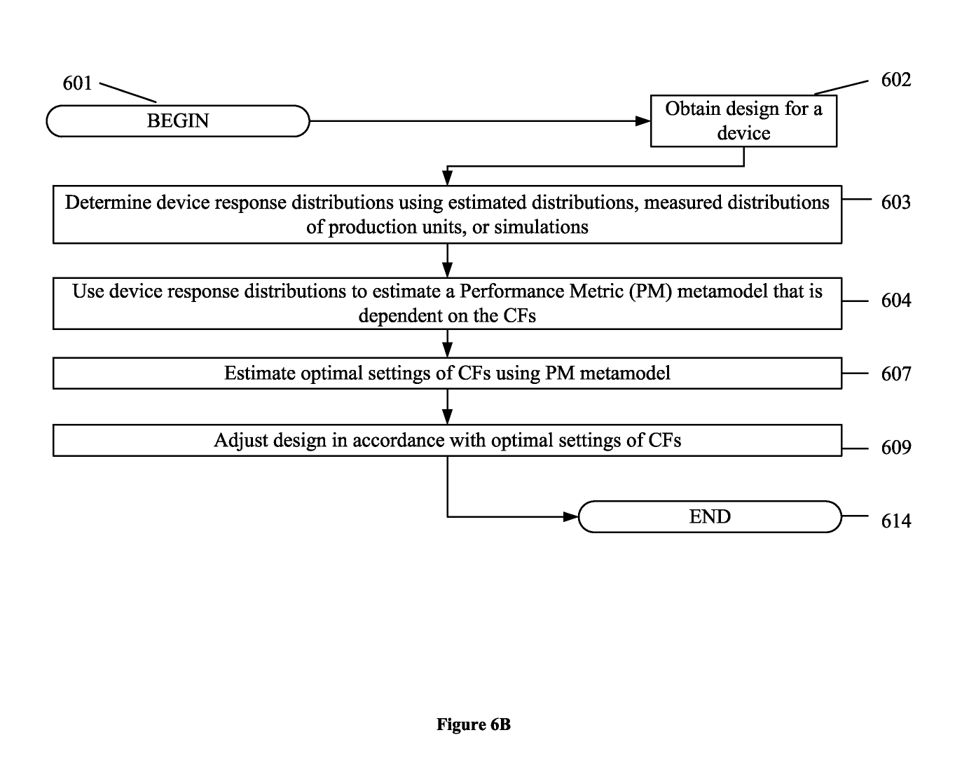

Referring now to FIG. 6A, an embodiment method for using a performance metric model to verify candidate settings of the CFs and to generate a design from which a device may be manufactured. The method begins at step 601. At step 602, a preliminary design for the device is obtained. For example, if the device is an integrated circuit or other electronic circuit, its design may be a circuit layout, a circuit description database, or some other formal description of an electronic circuit. In accordance with this design, the device has a response that varies with varying values of k CFs and N−k UFs. The CF values may include, for example, component values of the design. At step 603, device response distributions are determined using either estimated distributions, measured distributions of production units, or simulations of a simulation model that is an electronic design replica. At step 604, the device response distributions are used to estimate a performance metric metamodel that is dependent on the CFs.

At step 606, a worst case value of the performance metric is estimated using the performance metric metamodel. At step 608, a flow decision is made based on whether the worst case performance metric value satisfies performance requirements such as, for example, a specification limit for Cₚₖ. If the worst case performance metric value does not satisfy the performance requirements, at step 610 the design is adjusted so that the performance metric value more closely satisfies the performance requirements. In this case the flow returns to step 603. If the worst case performance metric value satisfies the performance requirements, the flow continues at step 612, where new units of a device are manufactured in accordance with the design. Manufacturing the device may include, for example, generating a mask for an integrated circuit in accordance with the formal description, and then manufacturing the integrated circuit in accordance with the mask. The method ends at step 614.

Referring now to FIG. 6B, an alternative embodiment of the method of FIG. 6A is shown where CF settings may represent tunable design settings. In the embodiment of FIG. 6B, steps 606-612 of FIG. 6A have been replaced by steps 607 and 609. At step 607, settings of the CFs that optimize the performance metric are estimated using the performance metric metamodel. At step 609, the device is adjusted in accordance with the optimal CF settings.

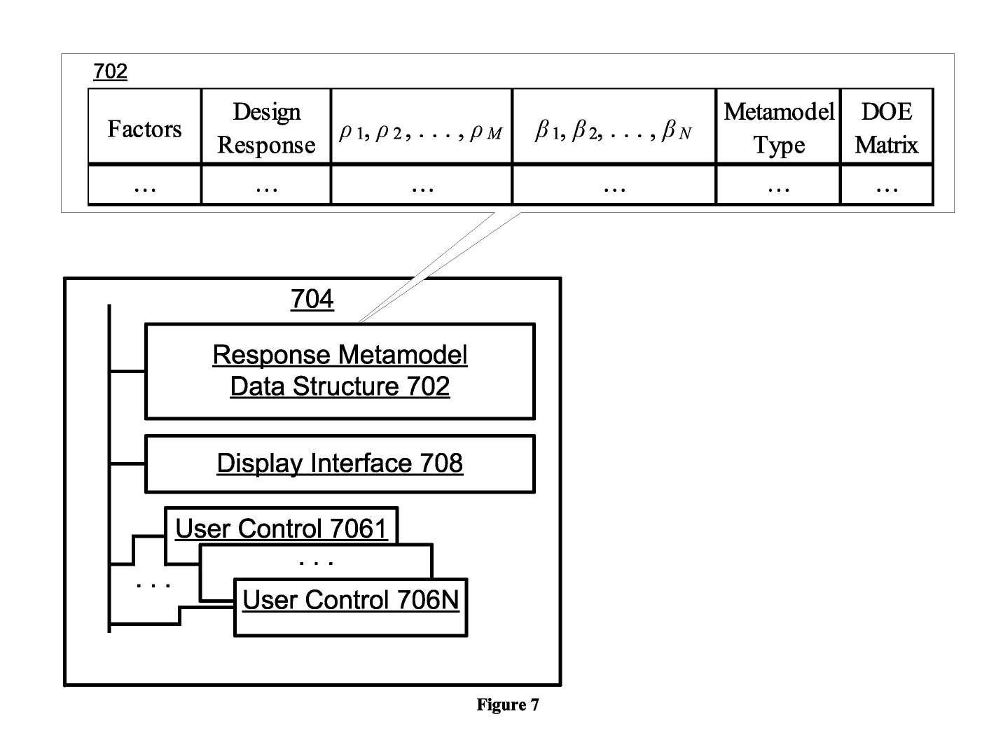

FIG. 7 is a block diagram illustrating an embodiment performance metric metamodel software tool 700 that includes a UI. The UI 704 includes a plurality of user controls 7061 to 706N and also includes a display interface 708. The software tool 700 may receive a pre-determined metamodel for the device response that has been stored in a pre-defined response metamodel data structure 702. The device response metamodel data structure 702 may include, for example, the following fields: descriptions and set values of factors (both CFs and UFs), a description and set value of a device response of interest, residual values ρ₁ to ρ_{N}, coefficient values β₁ to β_{N}, a DoE matrix for the metamodel, and the type of metamodel (polynomial order, etc.). Limits for the device response may also be included as a field of the metamodel data structure 702 or may alternatively be set by one of the plurality of user controls 7061 to 706N. These user controls 7061 to 706N may also allow a user to load the metamodel data structure 702 into the software tool 700, to select the CFs (the remaining factors that are not selected are treated as UFs), to modify the values of the CFs, to select a desired performance metric, and to choose an optimization option that directs computing the optimal setting of CFs that optimizes the selected performance metric. The display interface 708 may display a distribution of the response for a given setting of the CFs, may provide near instantaneous updates to this distribution when the values of the CFs are modified, and may display the optimal values of the CFs. The software tool 700 may calculate a performance metric metamodel dependent on k CFs. Such a performance metric metamodel is a multidimensional surface of k+1 dimensions. The display interface 708 may interactively display selected performance metric-CF surface subplots of a lesser number of dimensions while some of the CFs are held constant. For example, user controls 7061 to 706N may allow the user to select a display of k one-dimensional subplots that respectively plot the selected performance metric against each of the k CFs, while the remaining k−1 CFs are maintained at a user setting during the sweep of the respective subplot. The display interface 708 may also display a three-dimensional plot of the selected performance metric against two CFs selected via user controls 7061 to 706N.

The user controls 7061 to 706N may also allow the user to set a limit for the performance metric. The display interface 708 may display a projection of the intersection between the performance metric-CF surface and the plane of the performance metric limit, where this intersection is projected onto the plane of the two CFs. In some embodiments, this projection plot may be useful for finding the range of factor values in which the performance metric limit is satisfied.

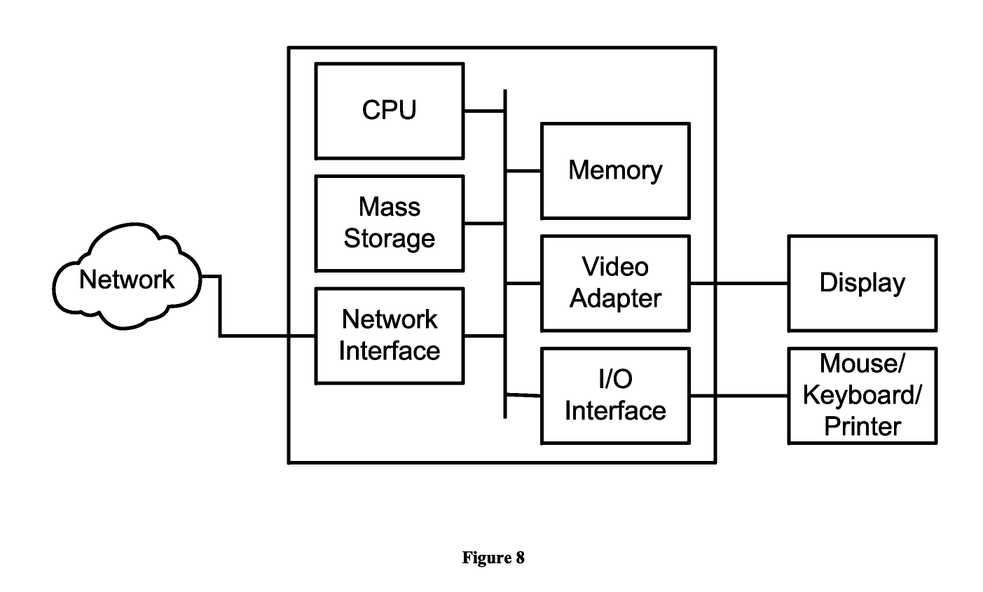

FIG. 8 shows a block diagram of a processing system that may be used for implementing some of the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. In an embodiment, the processing system comprises a computer workstation. The processing system may comprise a processing unit equipped with one or more input/output devices, such as a speaker, microphone, mouse, touchscreen, keypad, keyboard, printer, display, and the like. The processing unit may include a CPU, memory, a mass storage device, a video adapter, and an I/O interface connected to a bus. In an embodiment, multiple processing units in a single processing system or in multiple processing systems may form a distributed processing pool or distributed editing pool.

The bus may be one or more of any type of several bus architectures including a memory bus or memory controller, a peripheral bus, video bus, or the like. The CPU may comprise any type of electronic data processor. The memory may comprise any type of system memory such as random access memory (RAM), static RAM (SRAM), dynamic RAM (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface such as Universal Serial Bus (USB) (not shown) may be used to provide an interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like. The network interface may be configured to have various connection-specific virtual or physical ports communicatively coupled to one or more of these remote devices.

Illustrative embodiments of the present invention have the advantage of minimizing the number and cost of experiments necessary for testing factors that cause variation of the responses of a product being designed or evaluated. An embodiment system may use, for example, a linear regression prediction model of a unimodal or multimodal device response so that a factor-dependent model of a performance metric may be calculated over a wide range of factor settings at a low cost. Further advantages of embodiments may include, for example, assessing production yield at a worst case of a performance metric value.

The following additional example embodiments of the present invention are also provided. In accordance with a first example embodiment of the present invention, there is provided a performance estimation method including determining, for a device response that is dependent on first factors and second factors, a plurality of response distributions including at least one of: a measured response distribution of a production set corresponding to a setting of the first factors, the production set including a plurality of manufactured units; a response distribution simulated in accordance with a simulation model and with a combined factor setting of the first factors and the second factors; and a response distribution estimated in accordance with the combined factor setting and in accordance with a response prediction model relating the device response to the first factors and to the second factors. The method also includes estimating, in accordance with the plurality of response distributions, a performance metric prediction model relating a performance metric to the first factors.

Also, the foregoing first example embodiment may be implemented to include one or more of the following additional features. The method may also be implemented to further include: simulating values of the device response in accordance with the simulation model and in accordance with settings of N factors including the first factors and the second factors; determining linear regression coefficients of the response prediction model in accordance with the simulated values of the device response; generating, for each of a plurality of settings of the first factors, a respective plurality of random values of the second factors to determine combined factor settings; and estimating the plurality of response distributions in accordance with the combined factor settings. The method may also be implemented to further include: selecting the settings of the N factors in accordance with one of an A-optimal criterion, a D-optimal criterion, and a G-optimal criterion; and selecting the plurality of settings of the first factors in accordance with one of an A-optimal criterion, a D-optimal criterion, and a G-optimal criterion, where the response prediction model further includes a second-order polynomial linear regression model, and the performance metric prediction model further includes a second-order polynomial linear regression model. The method may also be implemented where the first factors include at least one: of a software setting, a pre-determined temperature, a supply voltage, and a design component value; and the second factors include at least one of a production process parameter, a load characteristic, a randomly varying electrical input, and a randomly varying temperature. The method may also be implemented where the estimating the performance metric prediction model includes determining linear regression coefficients in accordance with: the response distributions, an upper limit for the response distributions, and a lower limit for the response distributions; the performance metric includes one of process capability index, design index, failure probability, and worst case distance; and the response distributions are multimodal. The method may also be implemented to further include: selecting a candidate design; estimating a performance metric value in accordance with the candidate design and the performance metric prediction model; verifying the performance metric value satisfies a performance requirement; and manufacturing device units in accordance with the candidate design. The method may also be implemented where the manufacturing the device units includes: generating a mask for an integrated circuit in accordance with the candidate design, the candidate design including a formal description of an electronic circuit; and manufacturing the integrated circuit in accordance with the mask.

In accordance with a second example embodiment of the present invention, there is provided a performance estimation circuit configured to determine, for a device response that is dependent on first factors and second factors, a plurality of response distributions including at least one of: a measured response distribution of a production set corresponding to a setting of the first factors, the production set including a plurality of manufactured units; a response distribution simulated in accordance with a simulation model and with a combined factor setting of the first factors and the second factors; and a response distribution estimated in accordance with the combined factor setting and in accordance with a response prediction model relating the device response to the first factors and to the second factors. The circuit is also configured to estimate, in accordance with the plurality of response distributions, a performance metric prediction model relating a performance metric to the first factors.

Also, the foregoing second example embodiment may be implemented to include one or more of the following additional features. The circuit may be further configured to: simulate values of the device response in accordance with the simulation model and in accordance with settings of N factors including the first factors and the second factors; determine linear regression coefficients of the response prediction model in accordance with the simulated values of the device response; generate, for each of a plurality of settings of the first factors, a respective plurality of random values of the second factors to determine combined factor settings; and estimate the plurality of response distributions in accordance with the combined factor settings. The circuit may be further configured to: select the settings of the N factors in accordance with one of an A-optimal criterion, a D-optimal criterion, and a G-optimal criterion; and select the plurality of settings of the first factors in accordance with one of an A-optimal criterion, a D-optimal criterion, and a G-optimal criterion, where the response prediction model further includes a second-order polynomial linear regression model, and the performance metric prediction model further includes a second-order polynomial linear regression model. The circuit may also be implemented where the first factors include at least one of: a software setting, a pre-determined temperature, a supply voltage, and a design component value; and the second factors include at least one of a production process parameter, a load characteristic, a randomly varying electrical input, and a randomly varying temperature. The circuit may be further configured to: determine linear regression coefficients of the performance metric prediction model in accordance with the response distributions, an upper limit for the response distributions, and a lower limit for the response distributions; where the performance metric includes one of: process capability index, design index, failure probability, and worst case distance; and the response distributions are multimodal. The circuit may be further configured to: select a candidate design; estimate a value of the performance metric in accordance with the candidate design and the performance metric prediction model; and verify the performance metric value satisfies a performance requirement. The circuit may also be implemented to include a processor.

In accordance with a third example embodiment of the present invention, there is provided a method for fabricating an integrated circuit, including: selecting a candidate design; determining a plurality of response distributions each corresponding to a respective setting of first factors and a respective plurality of random values of second factors; estimating, in accordance with the plurality of response distributions, a performance metric prediction model relating a performance metric to the first factors; and estimating, in accordance with the performance metric prediction model, a performance metric value of the candidate design.

Also, the foregoing third example embodiment may be implemented to include one or more of the following additional features. The method may also be implemented to further include at least one of: verifying satisfaction of a performance requirement by the performance metric value; and adjusting, in accordance with the performance metric prediction model, a setting of the candidate design. The method may also be implemented to further include: generating, in accordance with candidate settings, a first design from which the integrated circuit may be manufactured, where the candidate design includes the first design, the first design includes one of a circuit layout and a circuit description database, the candidate settings include a value of a component of the integrated circuit, and the integrated circuit component includes one of: a resistor, an inductor, a capacitor, a diode, a transformer, an electronic oscillator, an analog filter, a digital filter, an operational amplifier, a power amplifier, and a transistor. The method may also be implemented where the plurality of response distributions include at least one of: a measured response distribution of a production set corresponding to a setting of the first factors, the production set including a plurality of manufactured units; a response distribution simulated in accordance with a simulation model and with a combined factor setting of the first factors and the second factors; and a response distribution estimated in accordance with the combined factor setting and in accordance with a prediction model of a response of the integrated circuit, the response prediction model relating the integrated circuit response to the first factors and to the second factors. The method may also be implemented to further include: simulating values of a response of the integrated circuit in accordance with the simulation model and in accordance with settings of N factors including the first factors and the second factors; determining linear regression coefficients of the response prediction model in accordance with the simulated values of the electronic circuit response; generating, for each of a plurality of settings of the first factors, a respective plurality of random values of the second factors to determine combined factor settings; and estimating the plurality of response distributions in accordance with the combined factor settings. The method may also be implemented to further include: selecting the settings of the N factors in accordance with one of an A-optimal criterion, a D-optimal criterion, and a G-optimal criterion; and selecting the plurality of settings of the first factors in accordance with one of an A-optimal criterion, a D-optimal criterion, and a G-optimal criterion, where the response prediction model further includes a second-order polynomial linear regression model, and the performance metric prediction model further includes a second-order polynomial linear regression model. The method may also be implemented to further include: determining linear regression coefficients of the performance metric prediction model in accordance with the response distributions, an upper limit for the response distributions, and a lower limit for the response distributions; where the second factors include at least one: of a production process parameter, a load characteristic, a randomly varying electrical input, and a randomly varying temperature; the performance metric includes one of process capability index, design index, failure probability, and worst case distance; and the response distributions are multimodal. The method may also be implemented where the response prediction model further includes first-order interactions, and the performance metric prediction model further includes first-order interactions.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A performance estimation method comprising:
determining, for a device response that is dependent on first factors and second factors, a plurality of response distributions comprising at least one of:
a measured response distribution of a production set corresponding to a setting of the first factors, the production set comprising a plurality of manufactured units;
a response distribution simulated in accordance with a simulation model and with a combined factor setting of the first factors and the second factors; and
a response distribution estimated in accordance with the combined factor setting and in accordance with a response prediction model relating the device response to the first factors and to the second factors; and
estimating, in accordance with the plurality of response distributions, a performance metric prediction model relating a performance metric to the first factors.

2. The method of claim 1, further comprising:
simulating values of the device response in accordance with the simulation model and in accordance with settings of N factors comprising the first factors and the second factors;
determining linear regression coefficients of the response prediction model in accordance with the simulated values of the device response;
generating, for each of a plurality of settings of the first factors, a respective plurality of random values of the second factors to determine combined factor settings; and
estimating the plurality of response distributions in accordance with the combined factor settings.

3. The method of claim 2, further comprising:
selecting the settings of the N factors in accordance with one of an A-optimal criterion, a D-optimal criterion, and a G-optimal criterion; and
selecting the plurality of settings of the first factors in accordance with one of an A-optimal criterion, a D-optimal criterion, and a G-optimal criterion, wherein:
the response prediction model further comprises a second-order polynomial linear regression model; and
the performance metric prediction model further comprises a second-order polynomial linear regression model.

4. The method of claim 1, wherein:
the first factors comprise at least one of a software setting, a pre-determined temperature, a supply voltage, and a design component value; and
the second factors comprise at least one of a production process parameter, a load characteristic, a randomly varying electrical input, and a randomly varying temperature.

5. The method of claim 1, wherein:
the estimating the performance metric prediction model comprises determining linear regression coefficients in accordance with the response distributions, an upper limit for the response distributions, and a lower limit for the response distributions;
the performance metric comprises one of process capability index, design index, failure probability, and worst case distance; and
the response distributions are multimodal.

6. The method of claim 1, further comprising:
selecting a candidate design;
estimating a performance metric value in accordance with the candidate design and the performance metric prediction model;
verifying the performance metric value satisfies a performance requirement; and
manufacturing device units in accordance with the candidate design.

7. The method of claim 6, wherein:
the manufacturing the device units comprises:
generating a mask for an integrated circuit in accordance with the candidate design, the candidate design comprising a formal description of an electronic circuit; and
manufacturing the integrated circuit in accordance with the mask.

8. A performance estimation circuit configured to:
determine, for a device response that is dependent on first factors and second factors, a plurality of response distributions comprising at least one of:
a measured response distribution of a production set corresponding to a setting of the first factors, the production set comprising a plurality of manufactured units;
a response distribution simulated in accordance with a simulation model and with a combined factor setting of the first factors and the second factors; and
a response distribution estimated in accordance with the combined factor setting and in accordance with a response prediction model relating the device response to the first factors and to the second factors; and
estimate, in accordance with the plurality of response distributions, a performance metric prediction model relating a performance metric to the first factors.

9. The circuit of claim 8, further configured to:
simulate values of the device response in accordance with the simulation model and in accordance with settings of N factors comprising the first factors and the second factors;
determine linear regression coefficients of the response prediction model in accordance with the simulated values of the device response;
generate, for each of a plurality of settings of the first factors, a respective plurality of random values of the second factors to determine combined factor settings; and
estimate the plurality of response distributions in accordance with the combined factor settings.

10. The circuit of claim 9, further configured to:
select the settings of the N factors in accordance with one of an A-optimal criterion, a D-optimal criterion, and a G-optimal criterion; and
select the plurality of settings of the first factors in accordance with one of an A-optimal criterion, a D-optimal criterion, and a G-optimal criterion, wherein:
the response prediction model further comprises a second-order polynomial linear regression model; and
the performance metric prediction model further comprises a second-order polynomial linear regression model.

11. The circuit of claim 8, wherein:
the first factors comprise at least one of a software setting, a pre-determined temperature, a supply voltage, and a design component value; and
the second factors comprise at least one of a production process parameter, a load characteristic, a randomly varying electrical input, and a randomly varying temperature.

12. The circuit of claim 8, further configured to:
determine linear regression coefficients of the performance metric prediction model in accordance with the response distributions, an upper limit for the response distributions, and a lower limit for the response distributions; wherein:
the performance metric comprises one of process capability index, design index, failure probability, and worst case distance; and
the response distributions are multimodal.

13. The circuit of claim 8, further configured to:
select a candidate design; estimate a value of the performance metric in accordance with the candidate design and the performance metric prediction model; and
verify the performance metric value satisfies a performance requirement.

14. The circuit of claim 8, comprising a processor.

15. A method for fabricating an integrated circuit, comprising:
selecting a candidate design;
determining a plurality of response distributions each corresponding to a respective setting of first factors and a respective plurality of random values of second factors;
estimating, in accordance with the plurality of response distributions, a performance metric prediction model relating a performance metric to the first factors; and
estimating, in accordance with the performance metric prediction model, a performance metric value of the candidate design.

16. The method of claim 15, further comprising at least one of:
verifying satisfaction of a performance requirement by the performance metric value; and
adjusting, in accordance with the performance metric prediction model, a setting of the candidate design.

17. The method of claim 15, further comprising:
generating, in accordance with candidate settings, a first design from which the integrated circuit may be manufactured, wherein:
the candidate design comprises the first design;
the first design comprises one of a circuit layout and a circuit description database;
the candidate settings comprise a value of a component of the integrated circuit; and
the integrated circuit component comprises one of a resistor, an inductor, a capacitor, a diode, a transformer, an electronic oscillator, an analog filter, a digital filter, an operational amplifier, a power amplifier, and a transistor.

18. The method of claim 15, wherein the plurality of response distributions comprise at least one of:
a measured response distribution of a production set corresponding to a setting of the first factors, the production set comprising a plurality of manufactured units;
a response distribution simulated in accordance with a simulation model and with a combined factor setting of the first factors and the second factors; and
a response distribution estimated in accordance with the combined factor setting and in accordance with a prediction model of a response of the integrated circuit, the response prediction model relating the integrated circuit response to the first factors and to the second factors.

19. The method of claim 18, further comprising:
simulating values of a response of the integrated circuit in accordance with the simulation model and in accordance with settings of N factors comprising the first factors and the second factors;
determining linear regression coefficients of the response prediction model in accordance with the simulated values of the electronic circuit response;
generating, for each of a plurality of settings of the first factors, a respective plurality of random values of the second factors to determine combined factor settings; and
estimating the plurality of response distributions in accordance with the combined factor settings.

20. The method of claim 19, further comprising:
selecting the settings of the N factors in accordance with one of an A-optimal criterion, a D-optimal criterion, and a G-optimal criterion; and
selecting the plurality of settings of the first factors in accordance with one of an A-optimal criterion, a D-optimal criterion, and a G-optimal criterion, wherein:
the response prediction model further comprises a second-order polynomial linear regression model; and
the performance metric prediction model further comprises a second-order polynomial linear regression model.

21. The method of claim 18, further comprising:
determining linear regression coefficients of the performance metric prediction model in accordance with the response distributions, an upper limit for the response distributions, and a lower limit for the response distributions; wherein:
the second factors comprise at least one of a production process parameter, a load characteristic, a randomly varying electrical input, and a randomly varying temperature;
the performance metric comprises one of process capability index, design index, failure probability, and worst case distance; and
the response distributions are multimodal.

22. The method of claim 21, wherein:
the response prediction model further comprises first-order interactions; and
the performance metric prediction model further comprises first-order interactions.
